(19) United States
(12) Patent Application Publication
(10) Pub. No.: US 2002/0179722 A1
(43) Pub. Date: Dec. 5, 2002

(54) Method of and a device for heating a house and the like

(76) Inventor: Raymond H. Young, Calgary (CA)

Correspondence Address: Ilya Zborovsky, 6 Schoolhouse Way, Dix Hills, NY, 11746, US

(21) Appl. No.: 09/865,559

(22) Filed: May 29, 2001

(51) Int. Cl. F23N 1/00; F23N 5/20; G05D 23/00

(52) U.S. Cl. 236/11; 236/46 R

(57) ABSTRACT

Heating of a house and the like is performed by sensing a need for heat by a thermostat; supplying gas into a furnace in response to a signal from the thermostat and burning the gas in the furnace; directing the burning gas to heat exchanging means so as to heat the heat exchanging means; blowing cool air by a fan past the heat exchanging means so as to heat the air; directing the heated air through heat ducts; operating the fan so that it always runs prior, during and after supplying the gas into the furnace for burning; and means for controlling the burning of gas electronically so as to limit a burning cycle to only substantially a few minutes with timed harvest cycles between the burning cycles during which harvest cycles the air is blown by the fan over the hot heat exchanging means and distributed through the heat ducts.

### BACKGROUND OF THE INVENTION

The present invention relates to a method of and a device for heating a house and the like.

For heating a house, natural gas fired forced air furnaces are utilized. The furnace operates in the following manner. A house thermostat senses a need for heat and closes a switch in its circuitry to allow power to flow through the thermostat and down to the gas valve in the furnace. The gas valve then opens and allows gas to flow through to the furnace burners where the gas is ignited by a pilot light or by an electronic ignition system. Natural gas burns between 900 and 1000° F. The exhaust heat provided by the burning gas is directed upwards inside the steel heat exchangers in the interior of the furnace and then outside through the chimney. While these hot gasses are moving around in the furnace, they lose a part of their heat to the steel heat exchangers, making the heat exchangers very hot, usually in excess of 300° F. When the burners are burning and the heat exchangers are heating up from the hot exhaust gasses inside them, the furnace blower (fan) starts blowing cool recirculated air past the outside of the heat exchangers. The cool air is heated by contact with the very hot heat exchangers and is directed through heat ducts to heat registers located in all parts of the house that need heat. The fan does not start until a low limit sensor indicates that the heat exchangers have reached a temperature of about 120° F. This process continues until the thermostat breaks its electrical circuit, thus indicating that enough heat has been produced. By this time the steel heat exchangers will have reached a temperature of 300° F. or more. If the exchangers get too hot a high limit sensor will shut off the gas valve and stops the burners. The fan does not stop at the point where the burners are shut off. The fan keeps on blowing air through the heat exchangers until they are cooled to a level satisfactory to the low level sensor. At that point, the low level sensor will shut off the fan.

There are several disadvantages in the method and the system described herein above. Although the gas burning, hot air systems have been around for many years, the cost of natural gas was so low that very little attention was paid to the furnace efficiency. When it got cool, the thermostat was adjusted and turned up, and the furnace came on and the heat was produced in a very simple and easy way. A few years ago the furnace manufacturers came up with an electronic ignition system that did away with the ever-burning pilot light. The advantage of this was in being able to sell a somewhat more advanced furnace. Some solutions are disclosed in U.S. Pat. Nos. 4,667,874; 4,369,916; 3,912,162; 4,136,730; 4,684,060; 4,773,586; 4,423,765; 4,337,893; 4,137,035; 4,356,962; and European patent document WO 98/32536 and the publication “2001 International AHR Exhibitor Highlights”, Appliance, Jan. 1, 2001. It is believed that the existing methods and systems can be further improved.

### SUMMARY OF THE INVENTION

Accordingly, it is an object of the present invention to provide an improved method of and a device for heating a house and the like.

In keeping with these objects and with others which will become apparent hereinafter, one feature of the present invention resides, briefly stated, in a method which includes sensing a need for heat by a thermostat; supplying gas into a furnace in response to a signal from the thermostat and burning the gas in the furnace; directing the burning gas to heat exchangers so as to heat the heat exchangers; blowing cool air by a fan past the heat exchangers so as to heat the air; directing the heated air through heat ducts; operating the fan so that it always runs prior, during and after supplying the gas into the furnace for burning; and controlling the burning of gas electronically so as to limit a burning cycle to only substantially a few minutes with timed harvest cycles between the burning cycles, during which harvest cycles the air is blown by the fan over the hot heat exchangers and distributed through the heat ducts.

In accordance with another feature of the present invention, a system includes a thermostat for sensing a need for heat; means for supplying gas into a furnace in response to a signal from the thermostat and burning the gas in the furnace; means for directing the burning gas to heat exchangers so as to heat the heat exchangers; a fan for blowing cool air past the heat exchangers so as to heat the air; means for directing the heated air through heat ducts; means for operating the fan so that it always runs prior, during and after supplying the gas into the furnace for burning; and means for controlling the burning of gas electronically so as to limit a burn cycle to only substantially a few minutes with timed harvest cycles between the burning cycles during which harvest cycles the air is blown by the fan over the hot heat exchangers and distributed through the heat ducts.

When the method is performed and the system is designed in accordance with the present invention, it further improves the efficiency of the operation of the furnace.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a view schematically illustrating a method of and a device for heating a house and the like, in accordance with the present invention.

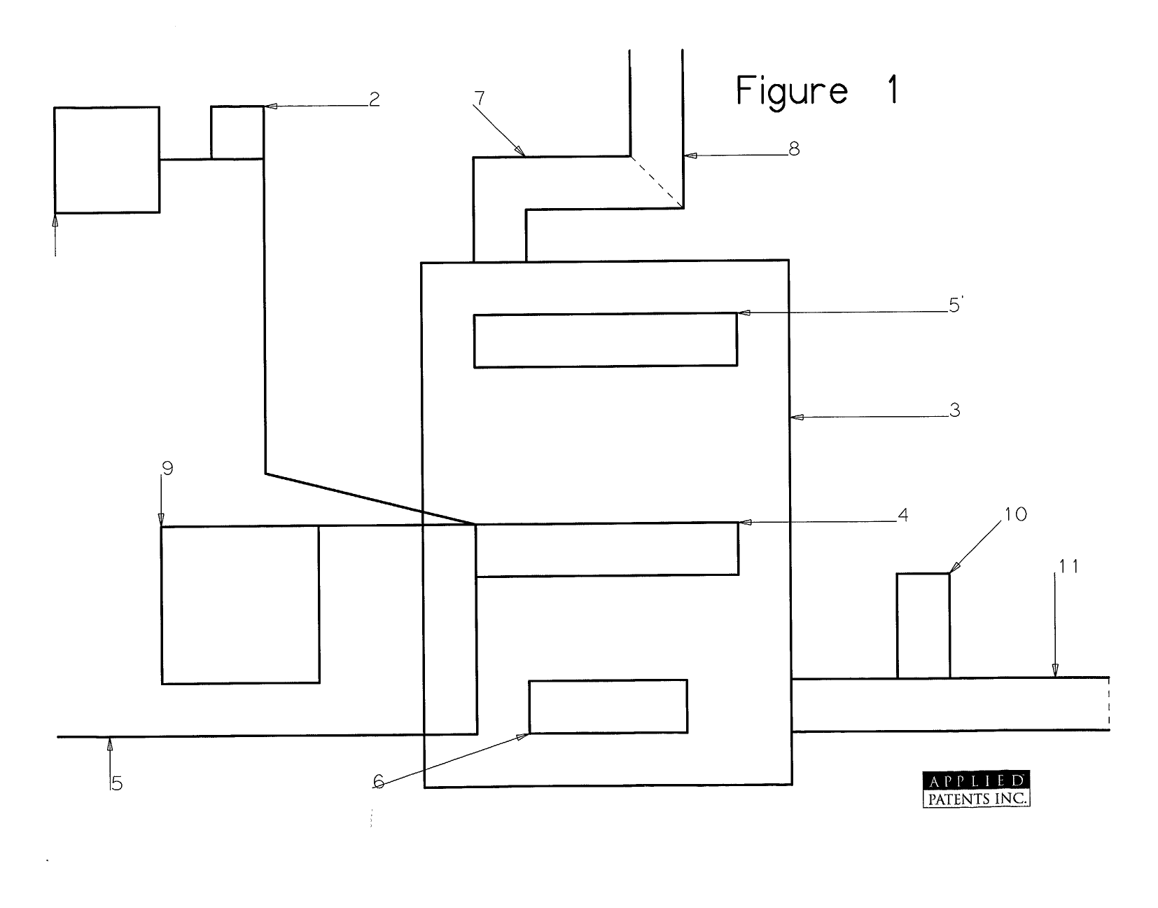

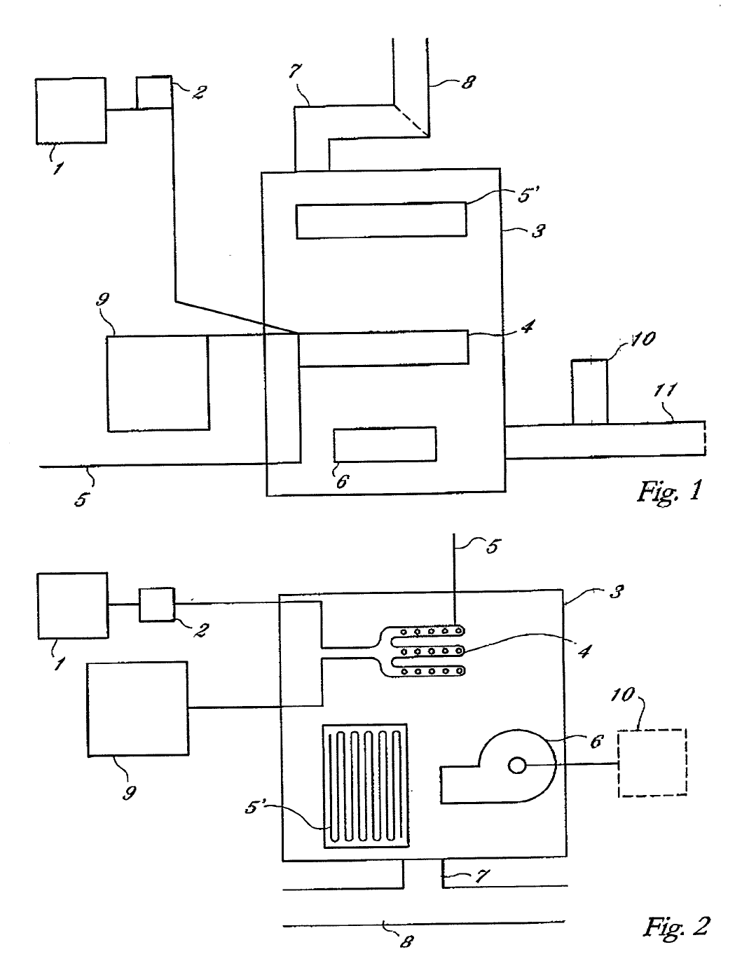

### DESCRIPTION OF THE PREFERRED EMBODIMENTS

A system in accordance with the present invention which operates in accordance with the inventive method has a thermostat which is identified with reference numeral 1 and provided with a switch 2. The system further includes a furnace which is identified as a whole with reference numeral 3. The furnace has burners 4, a gas supply line 5, heat exchangers 5′, a blower or fan 6 and a heated gas discharge line 7 connectable with chimney 8. In accordance with the present invention, an electronic timing and switching device 9 is provided, as will be explained herein below.

The inventive system operates in accordance with the inventive method in the following manner.

The fan 6 of the furnace 3 is turned on for example to a manual (or summer) setting and left running on continuously. This constant operation of the fan 6 does not affect the life of a fan motor, since an electric motor suffers most from wear and tear as a result of frequent stops and starts. The motor should be serviced, for example once per year, for oiling, cleaning, and the like.

Within hours of turning on of the fan 6, the house will begin to assume an even temperature in every part of the house in which heat registers connected with the heat ducts 11 are open. No hot spots, cool spots, or any areas of temperature differential occur in the house.

Most homes have humidistat controlled humidifiers and one of the humidifiers is identified with reference numeral 10. It turns off and on with the off and on action of the electric motor of the fan 6. With the fan 6 of the furnace to be running continuously, the humidistat is continuously powered and automatically turns the humidifier on and off to produce the humidity which has been selected. This results in a humidity which is very close to what is required by a user all the time. Because of the constant activation the house can be fine tuned with respect to humidity to precisely what is best for the user and the house.

When the natural gas fired/forced air furnace 3 is activated by the thermostat 1 through the switch 2, the burner 4 is ignited and continues to burn until the need for heat sensed by the thermostat 1 is satisfied and the thermostat 1 turns the burner 4 off. During the burning time the heat exchangers 5′ will be heated to a temperature of about 300° F. Once the thermostat is satisfied, the burners 4 are shut off, but the fan 6 of the heat exchanger continues to run until the heat exchangers 5′ are cooled. In the known systems this caused a heat over-run that often puts the house temperature 2-5° over the setting on the thermostat. The thermostat often will not call for heat until it is two degrees below the actual selected, set temperature. This manner of operation allows for a house temperature switching from two degrees below the actual setting to as much as five degrees above the actual setting, which is a seven degree variation. This is a very uncomfortable swing but is quite normal for natural gas fired, forced air furnaces. The air blowing through the heat registers is often so hot that a user can not stand barefoot on the register without burning his feet.

In the present invention the large end-of-cycle overruns and scorching heat air of the mid-run period are prevented. This is done electronically by the electronic timing and switching device 9. The electronic timing and switching device 9 controls the burning cycle to only a few minutes at any time, for example to only two minutes. In between these two minutes burns, there are timed harvest cycles that draw the recirculated air over the hot heat exchangers 5′ and distribute it through the house at a much more comfortable temperature. This burning/harvesting cycle continues until the thermostat 1 is satisfied and then the burning cycles are discontinued by the regular thermostat. The harvest cycles will continue until the heat exchangers are cooled. Because of a maximum heat exchanger temperature of substantially 120-250° F., instead of the standard 300° F., the heat overrun at the conclusion of the cycle is much shorter and much more moderate.

A natural gas usage saving of 35-50% will be achieved because of the continuous comfortable harvesting cycles which do not allow the burners 4 to continue pouring hot exhaust gasses into the heat exchangers 5′ when they are already saturated with heat. In contrast, in conventional furnace operations, heat supplied by the exhaust gasses that is excess to the absorbing capacity of the heat exchangers, is simply dumped up the chimney into the atmosphere. Thusly vented heat is of course nothing but pure waste of fuel.

It will be understood that each of the elements described above, or two or more together, may also find a useful application in other types of methods and constructions differing from the types described above.

While the invention has been illustrated and described as embodied in method of and a device for heating a house and the like, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

1. A method of heating a house and the like, comprising the steps of sensing a need for heat by a thermostat; supplying gas into a furnace in response to a signal from the thermostat and burning the gas in the furnace; directing the burning gas to heat exchanging means so as to heat the heat exchanging means; blowing cool air by a fan past the heat exchanging means so as to heat the air; directing the heated air through heat ducts; operating the fan so that it always runs prior, during and after supplying the gas into the furnace for burning; and controlling the burning of gas electronically so as to limit a burning cycle to only substantially a few minutes with timed harvest cycles between the burning cycles during which harvest cycles the air is blown by the fan over the hot heat exchanging means and distributed through the heat ducts.

2. A method as defined in claim 1; and further comprising continuing the operation with the burning cycles and harvest cycles until the thermostat no longer senses a need for heat.

3. A method as defined in claim 1; and further comprising maintaining a maximum heat exchanging means temperature of substantially 120 to 250° F.

4. A method as defined in claim 1; and further comprising powering a humidifier by the fan which is continuously running.

5. A method as defined in claim 1, wherein said controlling the burning cycle includes setting the burning cycle to substantially two minutes.

6. A system for heating a house and the like, comprising a thermostat for sensing a need for heat; a furnace provided with burning means and heat exchanging means for supplying gas into the furnace in response to a signal from the thermostat and burning the gas in the furnace; means for directing the burning gas to the heat exchanging means so as to heat the heat exchanging means; a fan blowing cool air past the heat exchanging mean so as to heat the air; means for directing the heated air through heat ducts; means for operating the fan so that it always runs prior, during and after supplying the gas into the furnace for burning; and means for controlling the burning of gas electronically so as to limit a burning cycle to only substantially a few minutes with timed harvest cycles between the burning cycles during which harvest cycles the air is blown by the fan over the hot heat exchanging means and distributed through the heat ducts.

7. A system as defined in claim 6, wherein said controlling means is formed so as to provide continuing the operation with the burning cycles and harvest cycles until the thermostat no longer senses a need for heat.

8. A system as defined in claim 6, wherein said controlling means is formed so as to provide maintaining a maximum heat exchanging means temperature of substantially 120 to 250° F.

9. A system as defined in claim 6; and further comprising a humidifier which is powered by the fan which is continuously running.

10. A method as defined in claim 6, wherein said controlling means is formed so as to provide setting the burning cycle to substantially two minutes.
